(19) United States
(12) Patent Application Publication
(10) Pub. No.: US 2009/0160196 A1
(43) Pub. Date: Jun. 25, 2009

(54) WIND DRIVEN ELECTRIC GENERATOR HAVING VERTICAL ROTATIONAL AXIS

(76) Inventor: James Metzloff, Buffalo, NY (US)

Correspondence Address: JAMES RAY & ASSOCIATES, 2640 PITCAIRN ROAD, MOROEVILLE, PA, 15146, US

(21) Appl. No.: 12/341,110

(22) Filed: Dec. 22, 2008

Related U.S. Application Data
(60) Provisional application No. 61/016,515, filed on Dec. 24, 2007.

(51) Int. Cl. F03D 3/00; F03D 9/00

(52) U.S. Cl. 290/55

(57) ABSTRACT

A wind turbine for a power generator includes a plurality of blades radially and equally spaced about a rotational axis, each blade having each of a proximal end, a distal end, a uniform thickness throughout, and an arc-shaped cross-section disposed between the proximal and distal ends in a plane traverse to the rotational axis and in a rotational direction of the turbine. Wind guiding members are interposed between the plurality of blades, each wind guiding member is attached to a respective pair of the adjacent blades and has a uniform thickness defined by a pair of substantially planar surfaces, a first end thereof disposed on and connected to the proximal edge of a leading blade and having an opposed second end thereof disposed substantially tangential on an exterior surface of an adjacent trailing blade. The wind turbine may be installed on a fixed structure or on an electric vehicle.

### CROSS-REFERENCE TO RELATED APPLICATIONS

This application is related to and claims priority from Provisional Patent Application Ser. No. 61/016,515 filed on Dec. 24, 2007.

### FIELD OF THE INVENTION

The present invention relates, in general, to power generators and, more particularly, this invention relates to an apparatus for converting wind power into mechanical or electric power and, yet particularly, the instant invention relates to wind driven vertical axis electric generator for moving vehicles.

### BACKGROUND OF THE INVENTION

As is generally well known, most homes and businesses utilize vast amounts of electric power and depend mostly on non-renewable energy resources or resources that are associated with higher than desirable production. Accordingly, the cost of the electric power has been continuously rising.

Due to continuously increasing costs, alternative sources of electric power generation, particularly generated by harvesting and converting wind power, have been gaining wide acceptance. However, the majority of the presently used wind turbines employ blade assemblies that rotate about a horizontally oriented shaft and are burdened by higher than desired costs of the supporting structure to sufficiently elevate relatively large blade assembly so that it does not strike the ground surface that these wind turbines are generally mounted on. Furthermore, due to its size, the wind turbines are mounted remotely from the electric energy use centers.

Prior to the conception and design of the present invention, efforts have been made to reduce the size and complexity of the prior art wind turbines. For example, U.S. Pat. No. 5,920,127 issued to Damron et al. provides an apparatus for generating electric power from wind that includes a base, a pair of upstanding, generally parallel, spaced apart walls rotatably mounted on the base and defining an inlet end and an outlet end for wind, an electric power generator mounted on the base and having an input shaft, and a vertical axis cylindrical rotor having a plurality of wind driven vanes and mounted on the base between the walls, and having an output shaft coupled to rotate the input shafts. A curved inner modulator is rotatably mounted on the base inside said rotor and is selectively movable for controlling wind flow through the rotor. An inlet modulator is rotatably mounted on the base at the inlet end and is selectively movable for controlling wind flow to the rotor. A first generally planar director is pivotally mounted on an outer surface of one of the walls and a second generally planar director is pivotally mounted on an inner surface of the other one of the walls and both directors are responsive to the wind for positioning the inlet end toward the wind. The electric generator of Damron et al. is also usable to power a vehicle.

However, there is a continuing need for an improved wind driven vertical axis electric generator capable of converting wind energy into mechanical or electric power.

### SUMMARY OF THE INVENTION

In a first aspect, the present invention provides a wind turbine for a power generator. The wind turbine includes a predetermined plurality of blades radially and substantially equally spaced about a rotational axis. Each of the predetermined plurality of blades has each of a proximal end, a distal end, a uniform thickness throughout, and an arc-shaped cross-section disposed between the proximal and distal ends in a plane traverse to the rotational axis. An exterior surface of the each blade has a convex shape in a rotational direction of the wind turbine. There is also a predetermined plurality of wind guiding members that are interposed between the predetermined plurality of blades. Each of the predetermined plurality of wind guiding members is attached to a respective pair of the predetermined plurality of blades and has a uniform thickness defined by a pair of substantially planar surfaces, a first end thereof disposed on and attached to the proximal edge of a leading blade and having an opposed second end thereof disposed substantially tangential on and attached to an exterior surface of an adjacent trailing blade.

In a second aspect, the present invention provides an electric power generating apparatus for a vehicle. The apparatus includes a blade assembly. The blade assembly includes a hub positioned to rotate about a vertical rotational axis. There is a predetermined plurality of blades radially and substantially equally spaced about the hub. Each of the predetermined plurality of blades has each of a proximal end, a distal end, a uniform thickness throughout, and an arc-shaped cross-section disposed between the proximal and distal ends in a plane traverse to the rotational axis. An exterior surface of the each blade has a convex shape in a rotational direction of the blade assembly. A predetermined plurality of wind guiding members also provided and interposed between to the predetermined plurality of blades. Each of the predetermined plurality of wind guiding members is attached to a respective pair of the predetermined plurality of blades and has a uniform thickness defined by a pair of substantially planar surfaces, a first end thereof disposed on and attached to the proximal edge of a leading blade and having an opposed second end thereof disposed substantially tangential on and attached to an exterior surface of an adjacent trailing blade. A generator is provided and is adapted to convert rotational motion at an input shaft thereof into electric power. There is also means for coupling the input shaft to the hub.

In a third aspect, the present invention provides an electric power generating apparatus for a vehicle. The apparatus includes a housing secured to the roof of the vehicle. The housing includes a housing body shaped to form a hollow interior space. An intake port is disposed at a front end of the housing body. The intake port angled downwardly a predetermined angle relative to a horizontal surface of the roof and extends a predetermined distance in a forward direction over a front windshield of the vehicle. There is also a discharge port that is disposed at a rear end of the housing body. The discharge port is angled downwardly a predetermined angle relative to the horizontal surface of the roof and extends a predetermined distance in a rearward direction over a rear windshield of the vehicle. At least one electrical generator is mounted within the hollow interior space of the housing body and is adapted to convert air flow from the intake port into electric power.

### OBJECTS OF THE INVENTION

It is, therefore, one of the primary objects of the present invention to provide an apparatus converting wind power into mechanical or electric power.

Another object of the present invention is to provide an apparatus converting wind power into mechanical or electric power that includes a wind turbine or blade assembly rotatable in a horizontal plane about a vertical axis.

Yet another object of the present invention is to provide an apparatus converting wind power into mechanical or electric power that employs arc-shaped blades.

A further object of the present invention is to provide an apparatus converting wind power into mechanical or electric power that employs arc-shaped blades and members for guiding wind power directly onto such blades.

Yet a further object of the present invention is to provide an apparatus converting wind power into mechanical or electric power that has a lighter weight as compared with conventional wind powered generators.

An additional object of the present invention is to provide an apparatus converting power energy into mechanical or electric power that is economical to manufacture.

Another object of the present invention is to provide an apparatus converting wind power into mechanical or electric power that can be installed on vehicles.

In addition to the several objects and advantages of the present invention which have been described with some degree of specificity above, various other objects and advantages of the invention will become more readily apparent to those persons who are skilled in the relevant art, particularly, when such description is taken in conjunction with the attached drawing Figures and with the appended claims.

### BRIEF DESCRIPTION OF THE DRAWINGS

FIG. 1 is a planar view of an electric power generating apparatus constructed in accordance with a presently preferred embodiment of the invention;

FIG. 2 is an elevation view of the electric power generating apparatus of FIG. 1;

FIG. 3 is a planar view of the electric power generating apparatus of FIG. 1, particularly illustrating its use on a vehicle;

FIG. 4 is an elevation view of the electric power generating apparatus of FIG. 3; and

FIG. 5 is an elevation view of the electric power generating apparatus constructed in accordance with an alternative embodiment of the present invention.

### BRIEF DESCRIPTION OF THE VARIOUS EMBODIMENTS OF THE INVENTION

Prior to proceeding to the more detailed description of the present invention, it should be noted that, for the sake of clarity and understanding, identical components which have identical functions have been identified with identical reference numerals throughout the several views illustrated in the drawing figures.

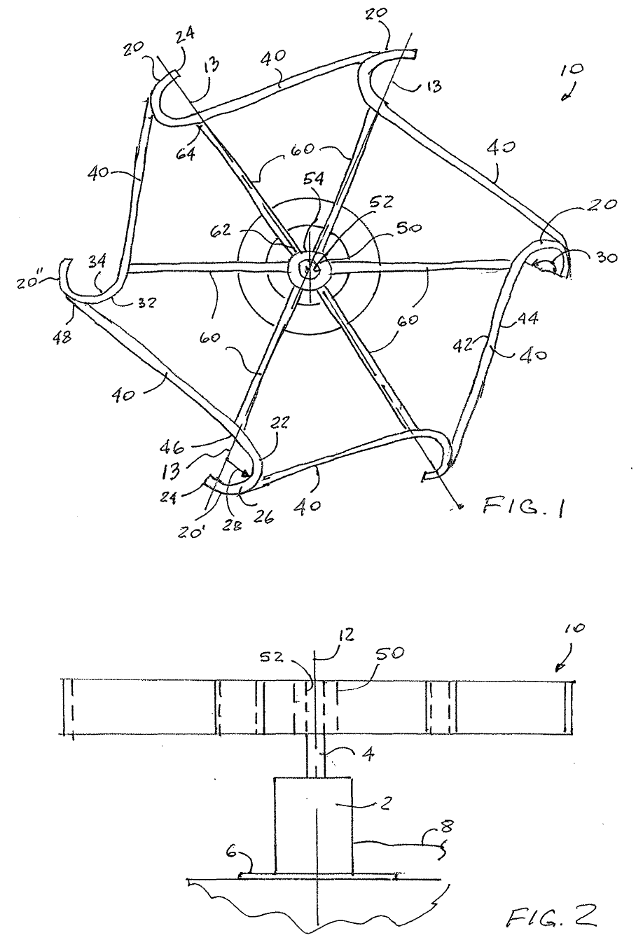

The best mode for carrying out the invention is presented in terms of its presently preferred embodiment, herein depicted within FIGS. 1 through 4. However, the invention is not limited to the described embodiment, and a person skilled in the art will appreciate that many other embodiments of the invention are possible without deviating from the basic concept of the invention and that any such work around will also fall under scope of this invention. It is envisioned that other styles and configurations of the present invention can be easily incorporated into the teachings of the present invention, and only one particular configuration shall be shown and described for purposes of clarity and disclosure and not by way of limitation of scope.

Reference is now made, to FIGS. 1-2, wherein there is shown a wind turbine, generally designated as 10, for an electric power generator 2. The wind turbine 10 includes a predetermined plurality of blades 20 radially and substantially equally spaced about a rotational axis 12. Each of the predetermined plurality of blades 20 has each of a proximal end 22, a distal end 24, a uniform thickness throughout, and an arc-shaped cross-section 26 disposed between the proximal and distal ends, 22 and 24 respectively in a plane traverse to the rotational axis 12 and in a rotational direction of the wind turbine 10. Preferably, the arc-shaped cross-section 26 has a uniform radius 28 throughout. It has been found that in order to improve operability of the wind turbine 10, the angle thirty (30) of the arc-shaped cross-section should be in a range between about one hundred and eight five (185) degrees and about one hundred and ninety five (195) degrees and preferably fixed at about one hundred and ninety 190 degrees. Thus, each blade 20 is substantially disposed to one side of the radial line 13 extending from the rotational axis 12 with only the distal end 24 and a portion of the blade 20 adjacent thereto crossing to the other side of radial line 13. In this arrangement, the exterior surface 32 has a convex shape in a direction of rotation of the turbine 10.

The wind turbine 10 further includes a predetermined plurality of wind guiding members 40 interposed between the predetermined plurality of blades 20. Each of the predetermined plurality of wind guiding members 40 is thus positioned between a pair of the predetermined plurality of blades 20. Each wind guiding member 40 preferably has a uniform thickness throughout defined by a pair of substantially planar and surfaces 42, 44. A first end 46 of the wind guiding member 40 is disposed on and attached to the proximal edge 22 of a leading blade 20, referenced with numeral 20′ for the sake of explanation. An opposed second end 48 of the wind guiding member 40 is disposed substantially tangential on and attached to an exterior surface 32 of an adjacent trailing blade 20, referenced with numeral 20″.

The wind turbine 10 further includes a hub 50 rotateable about the rotational axis 12 and coupled to an input shaft 4 of such power generator 2, in a number of conventional ways, in order to generate rotational motion thereof. By way of one example, of FIGS. 1-2, the hub 50 may be provided with axial aperture of bore 52 sized to operatively receive such input shaft 4.

In order to connect hub 50 to at least one of the predetermined plurality of the wind guiding members 40 and the predetermined plurality of blades 20, there is provided a predetermined plurality of radially spaced apart connecting members 60. Each of the predetermined plurality of radially spaced apart connecting members 60 has a first end 62 thereof disposed on and attached to an exterior surface 54 of the hub 50 and has an opposed end 64 thereof disposed on and attached to such at least one of the predetermined plurality of the wind guiding members 40 and the predetermined plurality of blades 20. The predetermined plurality of connecting members 60 facilitate weight reduction of the wind turbine 10. Subsequent weight reduction is achieved by employing a lightweight material in construction of the blades 20 and wind guiding members 40. For example, blades 20 may be manufactured from aluminum material and wind guiding members 40 may be manufactured from fiberglass material, each characterized by a light weight and sufficient rigidity to withstand rigors of operating environment. However, it is within the scope of the present invention to employ other conventional materials.

It is also within the scope o the present invention to form blades 20, wind guiding members 40, hub 50 and connecting members 60 integral with each other either from the same material or from combination of at least two distinct materials.

In operation, the wind or air flow/ pressure is received at the interior surface 34 of the blade 20 thus enabling rotational motional of the wind turbine 10. The arc-shaped cross-section 26 facilitates temporary “caging” of the wind power to increase torques onto the rotating input shaft 4. Advantageously, each wind guiding member 40 guides such wind or air flow directly to respective blade 20 positioned upstream thus, preventing the wind or air flow in a direction that would resist rotation, for example as toward the rotational axis in the conventional wind turbines and, more importantly, further increasing torque onto the rotating input shaft 4. Thus, the wind turbine 10 of the present invention is advantageous to increase operational efficiency of converting wind power into electric power.

According to a presently preferred embodiment of the invention, the wind turbine 10 is mounted so as to align the rotating axis 12 in a vertical direction and subsequently rotate the blades 20 in a horizontal plane. Such mounting is advantageous for reducing the load carrying structural requirement for foundation or base 6 to support the wind turbine 10. Thus, the turbine 10 can be mounted in close proximity to any elevated horizontal surface, for example such as a roof surface of a dwelling. However, the present invention also contemplates that the winds turbine 10 of FIGS. 1-2 may be installed for rotation about a horizontally disposed rotational axis, either on new installations or to retrofit presently employed apparatuses for generating electric power from wind power.

The height and width (or diameter) of the turbine 10 as well as the number of blades 20 are selected based on the required electric power to be generated, available supporting structure, materials used in a construction of the wind turbine 10 and various combinations thereof.

Any conventional electric generator 2 of the type having a rotating input shaft 4 and capable of converting rotational motion of the input shaft 4 into electric power by way of rotor and stator or other means may be employed in the present invention. The generator 2 may be mounted on the base 6. Equally as well, connection 8 of the electric generator 2 to an electric power storage means, such as a battery or a grid (not shown), is also achieved in accordance with conventional arrangements. Thus, the detail descriptions of such electric generator 2 and its connection to energy storage means are omitted in this application for the sake of brevity.

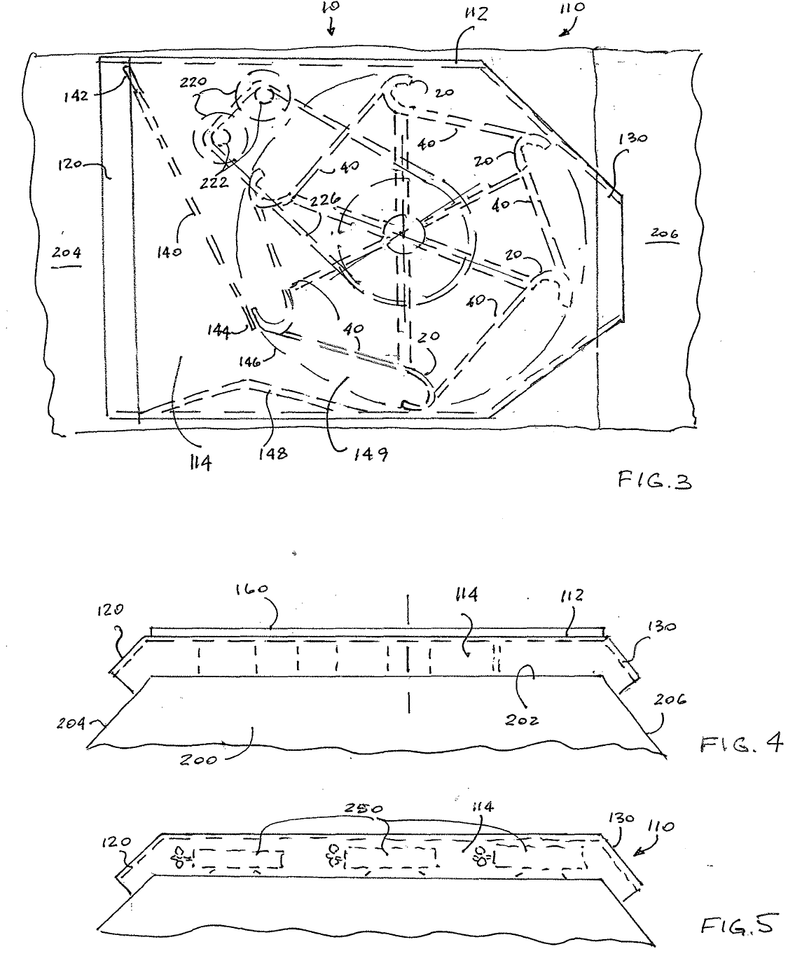

One advantageous application of the wind turbine 10 of the present invention is illustrated in FIGS. 3-4 in combination with a vehicle 200 that could be powered by an internal combustion engine and is preferably powered by way of electric power. Such wind turbine 10 is mounted for rotation in a horizontal plane on the roof 202 of the vehicle 200, although other locations, for example underneath the passenger compartment, are also contemplated by the present invention. The wind turbine 10 is coupled to the electric generator 220 either directly, wherein the hub 50 is provided with the axial aperture or bore 52 sized to operatively receive an input shaft 222 of the electric generator 220 or connected thereto by power transmission means, including at least one belt 226.

Although the wind turbine 10 may be simply mounted on the roof 202 of the vehicle 200 in an exposed manner, it is presently preferred to adapt wind turbine 10 with a housing, generally designated as 110, that is secured to the roof 202 and encloses the wind turbine 10. The housing 110 includes a housing body 112 shaped to provide a hollow interior space 114. An intake port 120 is disposed at and defines a front end of the housing 110. A discharge port 130 is disposed at and defines a rear end of the housing 100. A front baffle 140 is mounted within the hollow space 114 of the housing body 112 so as to direct an air flow entering the intake port 120 onto one of the predetermined plurality of blades 20, wherein a proximal end 142 of the front baffle 140 is positioned in abutting and air tight engagement with one end of the intake port 120 and wherein a distal end 144 of the baffle 140 is positioned generally tangentially with an arc 146 formed by a rotation of the predetermined plurality of blades 20 and providing for operative rotational clearance with the exterior surface 32 of each blade 20. The rear end of the housing body 112 is tapered so as to direct the air flow toward the discharge port 130.

Preferably, the intake port 120 extends a predetermined distance, which is about six (6) inches, in a forward direction over a front windshield 204 of the vehicle 200 and is angled downwardly a predetermined angle relative to the roof 202. Downward angling of the intake port 120 improves suction of the wind into the housing body 112 and reduces the resistance. An angle of about forty five (45) degrees has been found advantageous for use in the present invention, although other angles, particularly allowed by the angle of the front windshield 204 are also contemplated. It is further preferred to set a width of the intake port 120 substantially equal to a width of the roof 202. Thus, the front baffle 140 will be inclined toward the other edge of the roof, as best shown in FIG. 4, increasing the velocity of the wind/air entered the hollow space 114 and, more particularly, increasing the rotational speed of the wind turbine 10. If required to further increase the rotational speed of the wind turbine 10 a second front baffle 148 is provided and is angled mediate ends thereof to create a channel 149 which is generally equal in width to the width of the blade 20.

The discharge port 130 also extends a predetermined distance in a rearward direction over a rear windshield 206 of the vehicle 200 and is also angled downwardly a predetermined angle of about forty five (45) degrees relative to the roof 202 to at least minimize the flow of air back into the interior hollow space 114. The discharge port 130 is centered on the roof 202 and its width is preferably set smaller than the width of the roof 202 so as to facilitate the discharge of the air flow from the housing 110.

Now in a particular reference to FIG. 5, the housing 110 has been also found advantageous for use with a predetermined plurality of conventional electric generators 250 of the type disclosed in U.S. Pat. No. 5,920,127 issued to Damron et al. to increase efficiency of generating electric power. Teachings of U.S. Pat. No. 5,920,127 are incorporated into this document by reference thereto.

Although the present invention has been shown in terms of the wind turbine 10 for generating electric power, it will be apparent to those skilled in the art, that the present invention may be applied to mechanical power generation, by connecting the wind turbine to a shaft of a mechanical apparatus, for example such as a pump.

Furthermore, while only eight (8) blades are shown, any number of blades can be used depending on requirements for electric power to be generated Additionally at least one solar panel 160 may mounted on an exterior surface of the housing body 112 and used in combination with the wind turbine 10 or the electric generators 250.

Thus, the present invention has been described in such full, clear, concise and exact terms as to enable any person skilled in the art to which it pertains to make and use the same. It will be understood that variations, modifications, equivalents and substitutions for components of the specifically described embodiments of the invention may be made by those skilled in the art without departing from the spirit and scope of the invention as set forth in the appended claims.

I claim:

1. A wind turbine for a power generator, said wind turbine comprising:
(a) a predetermined plurality of blades radially and substantially equally spaced about a rotational axis, each of said predetermined plurality of blades having each of a proximal end, a distal end, a uniform thickness throughout, and an arc-shaped cross-section disposed between said proximal and distal ends in a plane traverse to said rotational axis, wherein an exterior surface of said each blade has a convex shape in a rotational direction of said wind turbine; and
(b) a predetermined plurality of wind guiding members interposed between said predetermined plurality of blades, each of said predetermined plurality of wind guiding members attached to a respective pair of said predetermined plurality of blades and having a uniform thickness defined by a pair of substantially planar surfaces, a first end thereof disposed on and attached to said proximal edge of a leading blade and having an opposed second end thereof disposed substantially tangential on and attached to an exterior surface of an adjacent trailing blade.

2. The wind turbine, according to claim 1, wherein said arc-shaped cross-section has a uniform radius throughout.

3. The wind turbine, according to claim 2, wherein an angle of said arc-shaped cross-section is between about 185 degrees and about 195 degrees.

4. The wind turbine, according to claim 3, wherein an angle of said arc-shaped cross-section is about 190 degrees.

5. The wind turbine, according to claim 1, wherein said turbine includes a hub rotateable about said rotational axis and coupled to an input shaft of such power generator to generate rotational motion thereof, and a predetermined plurality of radially spaced apart connecting members, each of said predetermined plurality of radially spaced apart connecting members having a first end thereof disposed on and attached to an exterior surface of said hub and having an opposed end thereof disposed on and attached to said at least one of said predetermined plurality of said wind guiding members and said predetermined plurality of blades.

6. The wind turbine, according to claim 5, wherein said wind turbine further includes said power generator adapted to convert rotational motion at said input shaft thereof into electric power.

7. The wind turbine, according to claim 6, wherein said turbine further includes a vehicle and wherein each of said predetermined plurality of blades and predetermined plurality of wind guiding members are mounted for rotation in a horizontal plane.

8. In combination with a vehicle, an electric power generating apparatus comprising:
(a) a blade assembly including:
(i) a hub positioned to rotate about a vertical rotational axis,
(ii) a predetermined plurality of blades radially and substantially equally spaced about said hub, each of said predetermined plurality of blades having each of a proximal end, a distal end, a uniform thickness throughout, and an arc-shaped cross-section disposed between said proximal and distal ends in a plane traverse to said rotational axis, wherein an exterior surface of said each blade has a convex shape in a rotational direction of said blade assembly, and
(iii) a predetermined plurality of wind guiding members interposed between to said predetermined plurality of blades, each of said predetermined plurality of wind guiding members attached to a respective pair of said predetermined plurality of blades and having a uniform thickness defined by a pair of substantially planar surfaces, a first end thereof disposed on and attached to said proximal edge of a leading blade and having an opposed second end thereof disposed substantially tangential on and attached to an exterior surface of an adjacent trailing blade;
(b) a generator adapted to convert rotational motion at an input shaft thereof into electric power; and
(c) means for coupling said input shaft to said hub.

9. The apparatus, according to claim 8, wherein at least said blade assembly is mounted on a roof of said vehicle and wherein said apparatus includes a housing secured to said roof and enclosing said blade assembly, said housing including:
(a) a housing body shaped to form a hollow interior space,
(b) an intake port disposed at a front end of said housing body;
(c) a discharge port disposed at a rear end of said housing body; and
(d) a baffle mounted within said hollow interior space of said housing body so as to direct an air flow entering said intake port onto one of said predetermined plurality of blades, wherein a proximal end of said baffle is positioned in abutting and air tight engagement with one end of said intake port and wherein a distal end of said baffle is positioned tangentially with an arc formed by a rotation of said predetermined plurality of blades.

10. The apparatus, according to claim 9, wherein said intake port extends a predetermined distance in a forward direction over a front windshield of said vehicle.

11. The apparatus, according to claim 9, wherein said intake port is angled downwardly a predetermined angle relative to a horizontal surface of said roof.

12. The apparatus, according to claim 9, wherein a width of said intake port is substantially equal to a width of said roof.

13. The apparatus, according to claim 9, wherein said discharge port extends a predetermined distance in a rearward direction over a rear windshield of said vehicle.

14. The apparatus, according to claim 9, wherein said discharge port is angled downwardly a predetermined angle relative to a horizontal surface of said roof.

15. The apparatus, according to claim 9, wherein a width of said discharge port is smaller than a width of said roof and wherein said discharge port is centered thereon.

16. The apparatus, according to claim 8, wherein said coupling means includes at least one belt.

17. The apparatus, according to claim 8, wherein said coupling means includes direct connection between said input shaft and said hub.

18. In combination with a vehicle, an electric power generating apparatus comprising:
(a) a housing secured to a roof of said vehicle, said housing including:
(i) a housing body shaped to form a hollow interior space,
(ii) an intake port disposed at a front end of said housing body, said intake port angled downwardly a predetermined angle relative to a horizontal surface of said roof and extending a predetermined distance in a forward direction over a front windshield of said vehicle; and
(iii) a discharge port disposed at a rear end of said housing body, said discharge port angled downwardly a predetermined angle relative to said horizontal surface of said roof and extending a predetermined distance in a rearward direction over a rear windshield of said vehicle; and
(b) at least one electrical generator mounted within said hollow interior space of said housing body and adapted to convert air flow from said intake port into electric power.
